(19) United States
(12) Patent Application Publication
(10) Pub. No.: US 2020/0348018 A1
(43) Pub. Date: Nov. 5, 2020

(54) Boiler Tube and Boiler Tube Unit and Furnace

(71) Applicant: Sandvik Intellectual Property AB, Sandviken (SE)

(72) Inventors: Urban FORSBERG, Sandviken (SE); Erika HEDBLOM, Valbo (SE)

(73) Assignee: Sandvik Intellectual Property AB, Sandviken (SE)

(21) Appl. No.: 16/763,256

(22) PCT Filed: Nov. 9, 2018
(86) PCT No.: PCT/EP2018/080793

§ 371 Date: May 12, 2020

(30) Foreign Application Priority Data
Nov. 17, 2017 (EP) 17202312.9

(51) Int. Cl. F22B 37/38; F22B 37/10; F16L 9/02; G01K 1/14; G01K 13/02

(52) U.S. Cl. CPC F22B 37/38; F22B 37/101; F22B 37/102; F22B 19/00; G01K 1/143; G01K 13/02; F16L 9/02

(57) ABSTRACT

Herein a boiler tube (2) having a longitudinal extension (L) and comprising radially inner and outer tubular portions (4, 6) extending along at least a first part (5) of the longitudinal extension (L). The radially outer tubular portion (6) is metallurgically bonded to the radially inner tubular portion (4). A sensor space (8) is arranged between the radially inner tubular portion (4) and the radially outer tubular portion (6), wherein the sensor space (8) is configured to accommodate a sensor arranged to detect a physical property of the radially outer tubular portion (6). A duct (10) is connected to the sensor space (8) and extends through the radially outer tubular portion (6) to an exit portion (12) of a surface of the radially outer tubular portion (6). The radially inner and outer tubular portions comprise materials of different chemical composition. Also, a boiler tube unit and a furnace are disclosed herein.

### TECHNICAL FIELD

The disclosure relates to a boiler tube and to a boiler tube unit. The disclosure also relates to a furnace. Further, the disclosure relates to a method of manufacturing a boiler tube.

### BACKGROUND

A furnace of an industrial boiler comprises so-called waterwall panels, which are panels formed of multiple parallel tubes, boiler tubes, welded to each other. Waterwall panels are arranged around at least part of the furnace. Inside the boiler tubes, water is heated to steam by the hot gases from the combustion in the furnace. The superheated steam may be used in industrial processes, and/or for production of electricity in a steam turbine.

Some of the boiler tubes, or portions of the boiler tubes, are subjected to large temperature differences between a circumferential half of the boiler tube arranged towards the inside of the furnace and being exposed to hot combusting matter, and/or combustion gases, and the other circumferential half arranged towards the outside of the furnace. Moreover, there may be a substantial temperature difference between the inside of a boiler tube, where water or steam flows, and the side of the boiler tube being exposed to combusting matter, and/or combustion gases. Thus, at least some of the boiler tubes are exposed to tough operating conditions, which provides large amount of stress on the boiler tubes.

Sooner or later the boiler tubes arranged in the areas of the furnace with the toughest operating conditions will rupture. This is not desirable as water or steam leaking into the furnace may cause damage to the furnace. Therefore, it is of interest to keep track of the temperatures, to which the boiler tubes are exposed on the inside of the furnace. With knowledge about material properties of the boiler tube, predictions may be made about when one or more boiler tubes of the furnace need to be replaced.

Measuring the temperature of the boiler tubes inside the furnace is very difficult since the temperatures are too high for normal temperature sensors and wiring to survive in the furnace.

WO 2010/100335 discloses an arrangement for mounting a sensor in a heat exchanger wall, which is formed of steel tubes welded next to each other with fin plates in between the tubes forming a membrane wall. A sensor chamber and a conductor channel required for sensor leads are located on the furnace side in a thickening of the wall of the steel tube. A sensor element to be attached to a tube wall is formed for the measurement sensor chamber as a homogeneous steel piece, comprising at least one length of steel tube, in which the wall thickening is formed.

US 2009/120383 discloses a pipe assembly for use in a boiler. The pipe assembly comprises a pipe having an outer wall adapted for heat exchange. The pipe has heat sensing means located in a recess section of the outer wall thereof, wherein an internal bore of the pipe has a substantially constant cross section in the region of the heat sensing means.

DE 10248312 discloses a measuring device for a heat exchanger comprising a pressure pipe and at least one thermal element. Said pressure pipe is provided with a pipe wall encompassing a recess which extends across a partial area of the circumference of the pipe wall, accommodates the thermal element, and is filled with filling material. The thermal element is disposed off-centre within the partial area that is deformed by the recess. As the filling material a welding material suggested.

However, providing a reliable connection for a sensor arranged in a boiler tube still poses a problem.

### SUMMARY

It would be advantageous to overcome, or at least alleviate, at least some of the above-mentioned problems related to measurement of temperature inside a boiler. To better address one or more of these concerns, a boiler tube, a boiler tube unit, and a furnace having the features defined in the independent claims are provided.

According to an aspect of the disclosure, there is provided a boiler tube having a longitudinal extension L and comprising a radially inner tubular portion extending along at least a first part of the longitudinal extension, a radially outer tubular portion extending along the first part of the longitudinal extension, the radially outer tubular portion being metallurgically bonded to the radially inner tubular portion, and a sensor space arranged between the radially inner tubular portion and the radially outer tubular portion, wherein the sensor space is configured to accommodate a sensor arranged to detect a physical property of the radially outer tubular portion, wherein a duct is connected to the sensor space and extends through the radially outer tubular portion to an exit portion of a surface of the radially outer tubular portion, and wherein the radially inner tubular portion and the radially outer tubular portion comprise materials of different chemical composition.

Since the boiler tube comprises a sensor space arranged between the radially inner tubular portion and the radially outer tubular portion, and since the sensor space is configured to accommodate a sensor arranged to detect a physical property of the radially outer tubular portion, a sensor may be arranged so that it is protected within the wall of the boiler tube inside the sensor space. Thus, there is provided a boiler tube, which permits a sensor to be arranged for detecting e.g. a temperature inside a furnace, or stress in a boiler tube without the sensor being directly exposed to the hot environment inside the furnace.

Moreover, since the radially inner tubular portion and the radially outer tubular portion comprise materials of different chemical composition, the chemical composition of the radially inner tubular portion may be adapted for contact with a medium, and a pressure, inside the boiler tube, and the chemical composition of the radially outer tubular portion may be adapted for contact with matter, and combustion gases, within a furnace. In addition, since the duct is connected to the sensor space, and extends through the radially outer tubular portion, connections may extend through the duct from the sensor space to the exit portion of a surface of the radially outer tubular portion. As the exit portion is provided in the radially outer tubular portion, being of a different chemical composition than the radially inner tubular portion, the entire duct extends underneath the radially outer tubular portion. Thus, the entire duct and the conduit extending therethrough benefits from the properties provided by the radially outer tubular portion, such as protection from matter and combustion gases within the furnace.

More specifically, the physical property of the radially outer tubular portion may for instance be a temperature of the radially outer tubular portion. A temperature on an outer surface of the boiler tube is detectable by detecting the temperature of the radially outer tubular portion within the sensor space. A known temperature gradient through the wall of the boiler tube, from the outer surface of the boiler tube to the inside of the boiler tube, with knowledge about the radial position of the sensor space, allows calculation of the temperature on the outside of the boiler tube based on the temperature sensed by the sensor in the sensor space.

Similarly, the physical property of the radially outer tubular portion may for instance be stress in the radially outer tubular portion. Stress in a boiler tube is detectable by detecting the stress of the radially outer tubular portion within the sensor space. Knowing the dimensions of the boiler tube, such as e.g. inner and outer diameters of the boiler tube, with knowledge about the radial position of the sensor space, allows calculation of the stress on the outside, or the inside, of the boiler tube based on the stress sensed by the sensor in the sensor space.

A boiler tube forms part of a furnace. More specifically, a boiler tube forms part of a so-called waterwall panel of a furnace. In use of a boiler tube, inside the boiler tube, water is heated to steam and may optionally be superheated to superheated steam. In use of the boiler tube, a first circumferential portion the boiler tube is subjected to ambient temperature around the furnace, and a second circumferential portion of the boiler tube is subjected to hot combusting matter, and/or combustion gases inside the furnace.

The term tubular portion refers to a tubular member as such. More specifically, the radially outer tubular portion forms a tubular member and the radially inner tubular portion forms a tubular member. As discussed above, the radially outer tubular portion is metallurgically bonded to the radially inner tubular portion. Accordingly, the radially outer tubular portion extends circumferentially around the entire, or substantially the entire, radially inner tubular portion.

The term metallurgically bonded means that an interface between to metal components, in this case the radially inner and outer tubular portions, forms a transitional zone. No clear interface line may be detected between the two metal components. Thus, during use of the boiler tube, when there exists a temperature difference between the inside of the boiler tube and the outside of the boiler tube, the metallurgical bond between the radially inner tubular portion and the radially outer tubular portion provides a continuous radial temperature distribution without any steps within the boiler tube, from an inside of the boiler tube to an outside of the boiler tube. Thus, the thermal conductivity may be the same, or may at least not exhibit any drastic stepwise change, at the interfaced between the radially inner tubular portion and the radially outer tubular portion. Similarly, the metallurgical bond provides for stress to be continuously distributed over the cross section of the boiler tube.

The sensor may for instance be a temperature sensor, such as a thermistor, or a stress sensor, such as a strain gauge. The duct forms a channel e.g. for electrical connections to extend to and from the sensor space.

Since the duct is connected to the sensor space and extends through the radially outer tubular portion to an exit portion of a surface of the radially outer tubular portion, electrical connectors to a sensor arranged in the sensor space may extend through the duct. Thus, the sensor arranged in the sensor space may be connected to control equipment of a furnace.

According to embodiments, the sensor space may be arranged in a first circumferential half of the boiler tube. The duct may extend partially around the radially inner tubular portion, and the exit portion may be arranged in a second circumferential half of the boiler tube. In this manner, the sensor space may be arranged at a circumferential half of the boiler tube arranged to face an inside of a furnace, while the exit portion is arranged at the other circumferential half of the boiler tube arranged to face towards an ambient environment outside the furnace. Thus, electrical connectors from a sensor arranged in the sensor space may exit the boiler tube towards the ambient environment of the furnace, where the temperature is lower compared to inside the furnace.

According to embodiments, the boiler tube may comprise a sensor arranged in the sensor space, and a conduit connected to the sensor extending through the duct. In this manner, the sensor may measure or monitor one or more physical properties of the boiler tube, and indirectly of a furnace in which the boiler tube is arranged. Via the conduit, which may be an electrical conduit, the sensor may be connected to control or monitoring equipment of the furnace.

According to embodiments, the sensor space and the duct may be formed by a tube partially positioned on the radially inner tubular portion and extending through the radially outer tubular portion, and wherein the radially outer tubular portion may be built up around the tube. In this manner, the tube may ensure that the sensor space and the duct are formed during the manufacturing of the boiler tube. Also, a correct position of the sensor space and the duct within the boiler tube may be ensured, since the tube may be placed in the correct position prior to forming the radially outer tubular portion.

According to embodiments, the radially outer tubular portion may be formed by means of hot isostatic pressing of a metal powder, whereby the radially outer tubular portion is metallurgically bonded to the radially inner tubular portion. In this manner, the metallurgical bond may be achieved. Thus, during use of the boiler tube, the radial temperature distribution, and/or the radial stress distribution, within the boiler tube may be continuous without any steps.

According to embodiments, the sensor space and the duct may be formed during additive manufacturing of the radially outer tubular portion onto the radially inner tubular portion. In this manner, the metallurgical bond between the radially inner tubular portion and the radially outer tubular portion may be achieved. Thus, during use of the boiler tube, the radial temperature distribution, and/o the radial stress distribution within the boiler tube may be continuous without any steps.

According to embodiments, the boiler tube may comprise a first longitudinal tube portion and a second longitudinal tube portion, the first longitudinal tube portion and the second longitudinal tube portion extending along the longitudinal extension L, wherein the first longitudinal tube portion is metallurgically bonded to the second longitudinal tube portion, and wherein the first longitudinal tube portion comprises the sensor space. In this manner, the boiler tube may comprise different portions along the longitudinal extension of the boiler tube. Thus, inter alia the first longitudinal tube portion comprising the sensor space may be manufactured in accordance with a first manufacturing method, and the second longitudinal tube portion may be manufactured in accordance with a second manufacturing method. The first manufacturing method may for instance comprise hot isostatic pressing, or additive manufacturing. The first and second longitudinal tube portions may be metallurgically bonded to each other e.g. via welding.

According to embodiments, the first longitudinal tube portion may comprise a bent tube portion, the sensor space being arranged in the bent tube portion. In this manner, the bent tube portion may be utilised for providing an opening in a waterwall of a furnace. That is, the bent tube portion may extend at least partially around the opening in the waterwall. Often a waterwall is subjected to high temperatures, and/or to high stress, at such an opening. Accordingly, the provision of the sensor space in the bent tube portion may provide for a sensor to be positioned at a portion of the waterwall where tough conditions prevail in a furnace.

According to embodiments, the boiler tube may comprise at least one fin extending radially from the radially outer tubular portion and extending at least partially along the longitudinal extension L. In this manner, the boiler tube may be provided with a member for attaching the boiler tube e.g. to a further boiler tube in a waterwall. More specifically, the at least one fin may be welded to an adjacent boiler tube of the waterwall, either directly to a circumferential surface of the adjacent boiler tube, or to a fin of the adjacent boiler tube.

According to embodiments, the fin may be formed integrally with the radially outer tubular portion. In this manner, the fin does not have to be welded to the radially outer tubular portion. Such welding would damage the duct between the sensor space and the outer surface portion. Accordingly, in such embodiments the duct may extend from one side of the fin to an opposite side of the fin. The duct suitably extends along the radially inner tubular portion and thus, extends underneath the fin.

According to embodiments, the at least one fin may comprise a layer made of the same material as the radially inner tubular portion. In this manner, the fin may be brought to provide similar physical properties as the radially inner tubular portion. For instance, heat conductivity of the material of the radially inner tubular portion may be better than that of the material of the radially outer tubular portion. Thus, with a layer of the fin made from the same material as the radially inner tubular portion, heat conductivity via the fin may be improved over that of a fin made entirely of the same material as that of the radially outer tubular portion. Suitably the layer made of the same material as the radially inner tubular portion extends in the main direction of the fin, i.e. between two boiler tubes.

Also, in these embodiments, the duct suitably extends along the radially inner tubular portion and thus, extends underneath the fin. A suitably sized opening or recess of the duct may be provided in the layer at, or close to, the radially inner tubular portion.

According to a further aspect of the disclosure, there is provided a boiler tube unit comprising a first boiler tube and a second boiler tube. The first boiler tube is a boiler tube according to any one of aspects and/or embodiments discussed herein and comprising at least one fin, wherein the first and second boiler tubes are connected to each other via the at least one fin, and wherein the duct extends from a first side of the at least one fin to a second side of the at least one fin.

Since the boiler tube unit comprises the first and second boiler tubes connected to each other via the at last one fin, and since the duct extends from a first side of the at least one fin to a second side of the fin, the boiler tube unit can be installed in a furnace without having to weld the first boiler tube to the second boiler tube. Thus, the duct and any connection, such as any electrical connection, arranged in the duct will not be affected or damaged by the heat that would be generated in a welding operation.

According to a further aspect of the disclosure, there is provided a furnace comprising at least a first waterwall panel, the first waterwall panel comprising a number of boiler tubes, wherein at least a first boiler tube of the number of boiler tubes is a boiler tube according to any one of aspects and/or embodiments discussed herein.

Since the boiler tube comprises a sensor space, as discussed above, a sensor may be arranged protected within the wall of the boiler tube inside the sensor space. Thus, there is provided a furnace with a first waterwall panel, which permits a sensor to be arranged for detecting a physical property, such as temperature, and/or stress, inside the furnace without the sensor being directly exposed to the hot environment inside the furnace.

Accordingly, the physical property of the boiler tube may be continuously monitored in particularly exposed positions of the furnace. Suitably the sensor space is arranged at such exposed positions. The continuous monitoring may enable furnace operators to increase their knowledge about operating conditions of the furnace, and to adjust these in different ways to mitigate negative consequences of certain operating conditions, or process disturbances. A constant measuring of operational data could enable earlier warnings to be able to plan for boiler tube replacements. Being able to establish a physical property, such as e.g. temperature, and/or stress, in critical areas of the furnace may be useful for detecting partial or complete blockage of boiler tubes, which may cause overheating and burning of the boiler tube.

The first waterwall panel may comprise multiple boiler tubes arranged extending in parallel with each other. The boiler tubes may be welded directly, or indirectly, to each other. One or more waterwall panels may be arranged around at least part of the furnace.

According to embodiments, the furnace may comprise a boiler tube unit according to any one of aspects and/or embodiments discussed herein, wherein the at least one first boiler tube forms the first boiler tube of the boiler tube unit. In this manner, welding across the duct is not required for installation of the first boiler tube in the furnace.

According to embodiments, the furnace may comprise a second waterwall panel, the first waterwall panel may form at least part of a sidewall of the furnace and the second waterwall panel may form at least part of a floor of the furnace. In this manner, water, and/or steam, and/or superheated steam, may be led along both the sidewall and the floor of the furnace.

The first boiler tube may form part of both the first and the second waterwall panels. Alternatively, or additionally, the second waterwall panel may comprise at least one boiler tube according to any one of aspects and/or embodiments discussed herein.

According to embodiments, the first boiler tube may be arranged with its sensor space close to an opening in the first waterwall panel. In this manner, a physical property at the opening in the first waterwall panel, which may be a particularly exposed portion of the first waterwall panel, may be monitored.

According to a further aspect of the disclosure, there is provided a method of producing a boiler tube, the boiler tube having a longitudinal extension L and comprising a radially inner tubular portion extending along at least a first part of the longitudinal extension, a radially outer tubular portion extending along the first part of the longitudinal extension. The method comprises steps of.
providing the radially inner tubular portion,
forming the radially outer tubular portion, and simultaneously during said forming achieve a
metallurgically bonding between the radially outer tubular portion and the radially inner tubular portion, and
forming a sensor space between the radially inner tubular portion and the radially outer tubular portion, wherein the sensor space is configured to accommodate a sensor arranged to detect a physical property of the radially outer tubular portion.

Further features of, and advantages with, the disclosure will become apparent when studying the appended claims and the following detailed description.

### BRIEF DESCRIPTION OF THE DRAWINGS

Various aspects and/or embodiments of the disclosure, including its particular features and advantages, will be readily understood from the example embodiments discussed in the following detailed description and the accompanying drawings, in which:

FIGS. 1-4 illustrate boiler tubes according to embodiments,

FIG. 5 illustrates embodiments of a method of manufacturing a boiler tube,

FIG. 6 illustrates a furnace according to embodiments, and

FIGS. 7a-7c illustrate embodiments of boiler tube units.

### DETAILED DESCRIPTION

Aspects and/or embodiments of the disclosure will now be described more fully. Like numbers refer to like elements throughout. Well-known functions or constructions will not necessarily be described in detail for brevity and/or clarity.

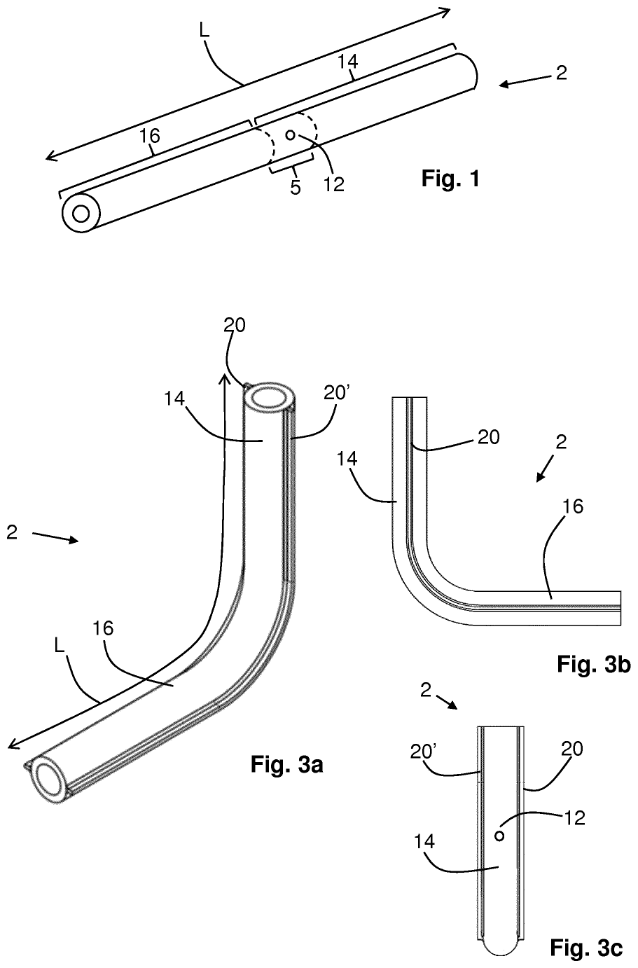

FIG. 1 illustrates a boiler tube 2 according to embodiments. The boiler tube 2 may form part of a furnace. The boiler tube 2 has a longitudinal extension L. The boiler tube 2 comprises a first longitudinal tube portion 14 and a second longitudinal tube portion 16. The first longitudinal tube portion 14 and the second longitudinal tube portion 16 extend along the longitudinal extension L. The first longitudinal tube portion 14 is metallurgically bonded to the second longitudinal tube portion 16. For instance, the first and second longitudinal tube portions 14, 16 may be metallurgically bonded to each other by welding.

Mentioned purely as an example, the longitudinal extension L of a boiler tube 2 may be within a range of 6-16 m. An outer diameter of the boiler tube 2 may be approximately 60 mm and an inner diameter of the boiler tube 2 may be approximately 50 mm.

Herein, a longitudinal direction, or longitudinal extension, of the boiler tube 2, extends along an axis of the boiler tube 2. Accordingly, the longitudinal direction/extension may be straight, as in FIG. 1, or bent as in FIG. 3a. A circumferential direction extends circularly, at least partially around the boiler tube 2. A radial direction extends radially inwardly or outwardly through a centre of the boiler tube 2.

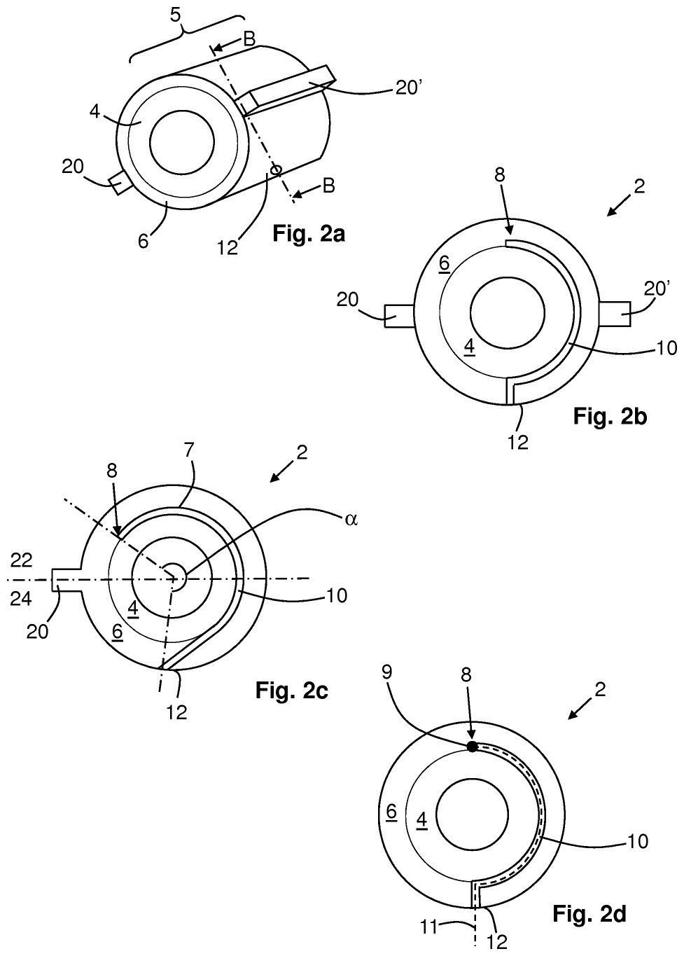

Along at least a first part 5 of the longitudinal extension L, the boiler tube 2 comprises a radially inner tubular portion and a radially outer tubular portion. A sensor space is arranged in the first part 5. See further below with reference to FIGS. 2a-2d.

The first part 5 may form only a portion of the first longitudinal tube portion 14, as indicated with the broken lines in FIG. 1. Alternatively, the first part 5 constitutes the first longitudinal tube portion 14. In the former case, the first part 5 is metallurgically bonded to the remaining portion of the first longitudinal tube portion 14, e.g. by welding.

The second longitudinal portion 16, and the part of the first longitudinal portion 14 not being the first part 5, may be made from a lower alloyed steel or from a carbon steel, in a radially inner portion, and from a corrosion resistant stainless steel or high alloyed steel in a radially outer portion. The two materials may be extruded to a tube with a diffusion bonding created between the two materials in the radially inner and outer portions.

The boiler tube 2 may comprise one or more further longitudinal portions in addition to the first and second longitudinal portions 14, 16.

FIGS. 2a-2d illustrate various embodiments of a boiler tube 2. In particular, FIGS. 2a-2d show different embodiments of a first part 5 of a boiler tube 2. In FIG. 2a a perspective view of a first part 5 is shown. In FIG. 2b a cross section along line B-B in FIG. 2a is shown. FIGS. 2c and 2d show corresponding cross sections as in FIG. 2b of first parts 5 according to alternative embodiments. In the following discussion reference is made to all of FIGS. 2a-2d, unless reference is specifically made to one or more of FIGS. 2a-2d.

Along at least the first part 5 of the longitudinal extension of the boiler tube 2, the boiler tube 2 comprises a radially inner tubular portion 4 and a radially outer tubular portion 6. The radially outer tubular portion 6 is metallurgically bonded to the radially inner tubular portion 4. In FIGS. 2a-2d the transitional zone between the radially inner and outer tubular portions 4, 6 is indicated with a circular line. In practice, the metallurgical bond between the radially inner and outer tubular portions 4, 6, forms a transitional zone having a radial extension, i.e. the interface between the radially inner and outer tubular portions 4, 6 is not distinct. The interface is formed by a diffusion bond between the two materials, i.e. the material of the radially inner tubular portion 4 and the material of the radially outer tubular portion 6.

The radially outer tubular portion 6 may be formed by hot isostatic pressing, HIP, of a metal powder. During HIP, the radially outer tubular portion 6 is also metallurgically bonded to the radially inner tubular portion 4.

Alternatively, the radially outer tubular portion 6 may be formed by additive manufacturing. During additive manufacturing, the radially outer tubular portion 6 is also metallurgically bonded to the radially inner tubular portion 4.

HIP and additive manufacturing are well known production methods, which are not described in more detail herein.

The radially inner tubular portion 4 and the radially outer tubular portion 6 comprise materials of different chemical composition. Mentioned purely as an example, the radially inner tubular portion 4 may comprise carbon steel or low-alloy steel, and the radially outer tubular portion 6 may comprise stainless steel or high alloyed steel. A carbon steel or low-alloy steel radially inner tubular portion 4 may be manufactured by hot rolling and/or cold drawing. The term chemical composition of a material relates to the proportions of the constituents of the material. Depending on how a particular portion of a boiler tube is manufactured, the structure in the different portions may vary.

According to some embodiments, the carbon steel may be a carbon steel according to standards ASTM: EN Number: 1.0425; EN Name: P265GH; which has a nominal chemical composition (weight %) of:

| | |
|---|---|
| Carbon (C) | max 0.2; |
| Manganese (Mn) | 0.7 to 1.4; |
| Silicon (Si) | max 0.4; |
| Chromium (Cr) | max 0.3; |
| Nickel (Ni) | max 0.3; |
| Copper (Cu) | max 0.3; |
| Molybdenum (Mo) | max 0.080; |
| Aluminum (Al) | max 0.024; |
| Titanium (Ti) | max 0.030; |
| Phosphorus (P) | max 0.025; |
| Niobium (Nb) | max 0.020; |
| Vanadium (V) | max 0.020; |

and balance Fe and unavoidable impurities.

According to some embodiments, the low-alloy steel may be a low-alloy steel according to standard EN Number: 1.5415, which has a nominal chemical composition (weight %) of:

0.12 to 0.2 wt % C;

max 0.35 wt % Si;

0.4 to 0.9 wt % Mn;

max 0.3 wt % Ni;

50.035% P;

50.035% S;

50.20% Cr;

0.25 to 0.35 wt % Mo,

max 0.012 wt % N;

max 0.3 wt % and

a balance of Fe and unavoidable impurities.

According to embodiments, the stainless steel or high alloyed steel may be selected from a nickel-chromium alloy such as, but not limited thereto, an alloy according to standard UNS N08825 or UNS N08028 or UNS N06690 or UNS N06625. These alloys have the following compositions:

An alloy according to UNS N08825 has the following composition in weight %:

| | |
|---|---|
| Ni | 38.0-46.0; |
| Cr | 19.5-23.5; |
| Mo | 2.5-3.5; |
| Cu | 1.5-3.0; |
| Ti | 0.6-1.2; |
| C | max 0.05; |
| S | max 0.03; |
| P | max 0.03; |
| Mn | max 1.0; |
| Si | max 0.5; |
| Al | max 0.2; |

balance Fe and unavoidable impurities.

An alloy according to UNS N08028 has the following composition in weight %:

| | |
|---|---|
| Ni | 30 to 34; |
| Cr | 26 to 28; |
| Mo | 3.0 to 4.0; |
| Mn | max 2.5; |
| Cu | 0.6 to 1.4; |
| Si | max 1.0; |
| C | max 0.030; |
| P | max 0.030; |
| S | max 0.030; |

balance Fe and unavoidable impurities.

An alloy according to UNS N06690 has the following composition in weight %:

| | |
|---|---|
| Cr | 27.0-31.0; |
| Fe | 7.0-11.0; |
| C | max 0.05; |
| Si | max 0.50; |
| Mn | max 0.50; |
| S | max 0.015; |
| P | max 0.015; |
| Cu | max 0.50; |

and balance Ni and unavoidable impurities.

An alloy according to UNS N06625 has the following composition in weight %:

| | |
|---|---|
| Cr | 20.0-23.0; |
| Fe | max 5.0; |
| Mo | 8.0-10.0; |
| Nb (+Ta) | max 0.10; |
| Mn | max 0.50; |
| S | max 0.50; |
| P | max 0.015; |
| S | max 0.015; |
| Al | max 0.40; |
| Ti | max 0.40; |
| Co | max 1.0; |

and balance Ni and unavoidable impurities.

Examples of impurities are elements and compounds which have not been added on purpose but cannot be fully avoided as they normally occur as impurities in e.g. the raw material or the additional alloying elements used for manufacturing of the relevant steel or alloy.

A sensor space 8 is arranged between the radially inner tubular portion 4 and the radially outer tubular portion 6. The sensor space 8 is configured to accommodate a sensor arranged to detect a physical property of the radially outer tubular portion 6. A duct 10 is connected to the sensor space 8 and extends through the radially outer tubular portion 6 to an exit portion 12 of a surface of the radially outer tubular portion 6.

The purpose of the duct 10 is twofold. Firstly, through the duct 10, a conduit may extend from the sensor space 8 to outside the boiler tube 2. Secondly, the extension of the duct 10 in a circumferential direction makes it possible for the exit portion 12 where the duct 10 exits to be positioned in an area of the boiler tube 2, which faces an ambient environment of the furnace, and thus, is subjected to less heat than an inside of the furnace.

The duct 10 may extend circumferentially about a portion of the radially inner tubular portion 4, and radially through the radially outer tubular portion 6, as shown in FIGS. 2b and 2d, or substantially tangentially through the radially outer tubular portion 6, as shown in FIG. 2c.

According to some embodiments, the sensor space 8 and the duct 10 may be formed by a tube 7 partially positioned on the radially inner tubular portion 4 and extending through the radially outer tubular portion 6, see FIG. 2c. The radially outer tubular portion 6 may be built up around the tube 7 during manufacturing of the radially outer tubular portion 6. The tube 7 may comprise the same chemical composition as the radially outer tubular portion 6. Thus, the thermal conductivity will be the same in the radially outer tubular portion 6 and the tube 7. Accordingly, heat transfer from an outside of the radially outer tubular portion 6 to a sensor in the sensor space 8, will be the same through the radially outer tubular portion 6 as through the tube 7.

The radially outer tubular portion 6 may be formed around the radially inner tubular portion 4 and the tube 7 by hot isostatic pressing, HIP. Alternatively, the radially outer tubular portion 6 may be formed around the radially inner tubular portion 4 and the tube 7 by additive manufacturing.

Mentioned purely as an example, the tube 7 may have an inner diameter within a range of 2-4 mm. The tube 7 may have any suitable cross-sectional shape, such as round, oval, square, or rectangular.

According to some embodiments, the sensor space 8 and the duct 10 may be formed during additive manufacturing of the radially outer tubular portion 6 onto the radially inner tubular portion 4. That is, while the different layers are made up during the additive manufacturing, void spaces are created. The void spaces eventually form the sensor space 8 and the duct 10 in the finished radially outer tubular portion 6.

The radially outer tubular portion 6 extends circumferentially around the radially inner tubular portion 4. Put differently, the radially outer tubular portion 6 is formed around the radially inner tubular portion 4, such that the radially outer tubular portion 6 extends circumferentially around the radially inner tubular portion 4.

Referring to FIG. 2d, due to the sensor space 8 and the duct 10, a sensor 9 arranged in the sensor space 8 may be connected via a conduit 11, such as an electrical conduit, extending through the duct 10. Thus, the sensor 9 may be connected to control or monitoring equipment of a furnace, of which the boiler tube 2 forms part. The sensor 9 is configured to measure or monitor one or more physical properties of the boiler tube 2, and thus, indirectly of the furnace.

According to some embodiments, the boiler tube 2 may comprise a heat conductive material arranged in the sensor space 8 at least partially around the sensor 9. In this manner, good heat transfer from the radially outer tubular portion 6 to the sensor 9 inside the sensor space may be ensured. For instance, the heat conductive material may comprise metal powder.

The sensor 9, and optionally the heat conductive material, may be installed via the conduit 11 in the sensor space 8 after the boiler tube 2 has been manufactured. For instance, the sensor 9 may be installed once the boiler tube 2 forms part of a furnace.

Heat from combusting matter and/or combustion gases within the furnace is transferred radially through the boiler tube 2 to the water, steam, or superheated steam inside the boiler tube 2. Heat transfer, radially through the boiler tube 2 depends on the thermal conductivity of the material, or materials, of the boiler tube 2. Due to the metallurgical bond between the radially inner and outer tubular portions 4, 6, thermal conductivity between the radially inner and outer tubular portions 4, 6 is good, in comparison with if the radially inner and outer tubular portions 4, 6 would only abut against each other. Thus, knowing the thermal conductivity of the radially inner and outer tubular portions 4, 6, measuring the temperature in the sensor space 8, i.e. the temperature of the radially outer tubular portion 6 in the sensor space 8, the temperature at the outer surface of the radially outer tubular portion 6 and the boiler tube 2, may be established.

Similarly, due to the metallurgical bond between the radially inner and outer tubular portions 4, 6, stress may be distributed within a cross section of the boiler tube 2, between the radially inner and outer tubular portions 4, 6. Thus, knowing the geometry of the boiler tube, measuring the stress of the boiler tube from the sensor space 8, stress at the outer surface of the radially outer tubular portion 6, and/or at the inner surface of the radially inner tubular portion 4 may be established, i.e. in portions of the boiler tube 2 where stress maybe the highest.

For the purpose of explaining the positions of the sensor space 8 and the exit portion 12 of the outer surface where the duct 10 exits the radially outer tubular portion 6, the boiler tube 2 may be divided into two imaginary circumferential halves as indicated by a straight dash-dotted line in FIG. 2c. A first circumferential half 22 is configured to face inwardly, towards the inside of the furnace, and a second circumferential half 24 is configured to face outwardly, towards an ambient environment of the furnace.

The sensor space 8 is arranged in the first circumferential half 22 of the boiler tube 2. The duct 10 extends partially around the radially inner tubular portion 4. The exit portion 12 is arranged in the second circumferential half 24 of the boiler tube 2. Thus, the sensor space 8 is arranged at the circumferential half 22 of the boiler tube 2 facing the inside of the furnace, and the exit portion 12 is arranged at the other circumferential half 24 of the boiler tube 2 facing the outside of the furnace.

Mentioned purely as an example, the circumferential angle α between the sensor space 8 and the exit portion 12, indicated in FIG. 2c, may be as small as 45 degrees, or approximately 180 degrees, as in FIGS. 2b and 2d, or more than 180 degrees, as in FIG. 2c.

FIGS. 3a-3c illustrate a boiler tube 2 according to embodiments. In FIGS. 3a-3c three different views of the boiler tube 2 are shown. Again, the boiler tube 2 comprises a first longitudinal tube portion 14 and a second longitudinal tube portion 16, the first longitudinal tube portion 14 and the second longitudinal tube portion 16 extending along the longitudinal extension L. The first longitudinal tube portion 14 is metallurgically bonded to the second longitudinal tube portion 16. The longitudinal extension L may be e.g. within a range of 6-16 m.

Again, at least a portion of the boiler tube 2 comprises radially inner and outer tubular portions metallurgically bonded to each other, with a sensor space arranged between the radially inner and outer tubular portions. In FIG. 3c there is shown the exit portion 12 of a surface of the radially outer tubular portion where a duct leading to the sensor space exits.

In these embodiments, the boiler tube 2 forms a 90-degree angle. Thus, the boiler tube 2 may extend over more than one waterwall panel of a furnace. For instance, the first longitudinal portion 14 may form part of a waterwall panel forming part of a side wall of the furnace, and the second longitudinal portion 16 may form part of a waterwall panel forming part of a floor of the furnace, or vice versa.

In order to connect the boiler tube 2 to other boiler tubes for forming a waterwall panel of a furnace, the boiler tube 2 comprise at least one fin 20, 20′ extending radially from the radially outer tubular portion 6. The at least one fin 20, 20′ extends at least partially along the longitudinal extension L.

In the embodiments of FIGS. 3a-3c, the boiler tube 2 comprises two fins 20, 20′ extending radially from the radially outer tubular portion 6 and extending at least partially along the longitudinal extension L, the two fins 20, 20′ being circumferentially separated by an angle of approximately 180 degrees.

The at least one fin 20, 20′ may be welded to an adjacent boiler tube of a waterwall panel, either directly to a circumferential surface of the adjacent boiler tube, or to a fin of the adjacent boiler tube.

Also, in FIGS. 2a-2c boiler tubes 2 comprising fins 20, 20′ are shown. In the embodiments of FIGS. 2a and 2b the boiler tube 2 comprises two fins 20, 20′. In the embodiments of FIG. 2c the boiler tube 2 comprises one fin 20.

The fins 20, 20′, as such, may be metallurgically bonded to the round portion of the boiler tube 2 during manufacturing of a boiler tube 2. For instance, a fin 20 may be welded to the round portion of the boiler tube 2.

According to alternative embodiments, the fin 20 may be formed integrally with the radially outer tubular portion 6, as shown in FIG. 2c. At least along the first part 5, the fin 20 may be formed integrally with the radially outer tubular portion 6. Accordingly, the fin 20 may be formed by HIP or additive manufacturing during building up of the radially outer tubular portion 6.

As shown in FIG. 2b, the duct 10 may extend from a first side of the fin 20′ to an opposite second side of the fin 20′. The duct 10 may extend along the radially inner tubular portion 4 and thus, may extend underneath the fin 20′. The relative term “underneath” is seen in a direction along the fin 20′ in a radial direction of the boiler tube 2 towards a centre of the boiler tube 2.

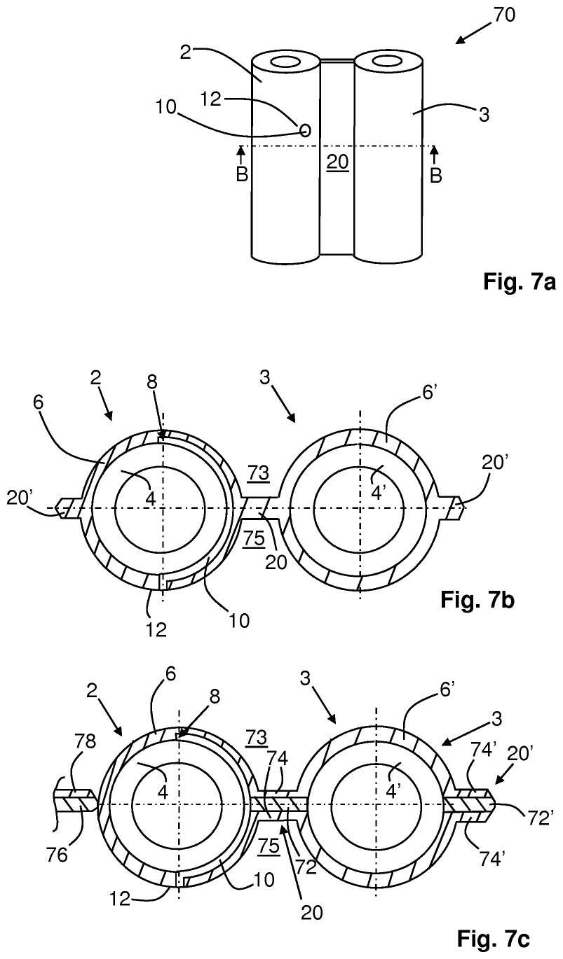

According to alternative embodiments, the at least one fin 20, 20′ may comprise a layer, such as for instance a core layer of the fin, made of the same material as the radially inner tubular portion, see further below with reference to FIG. 7c.

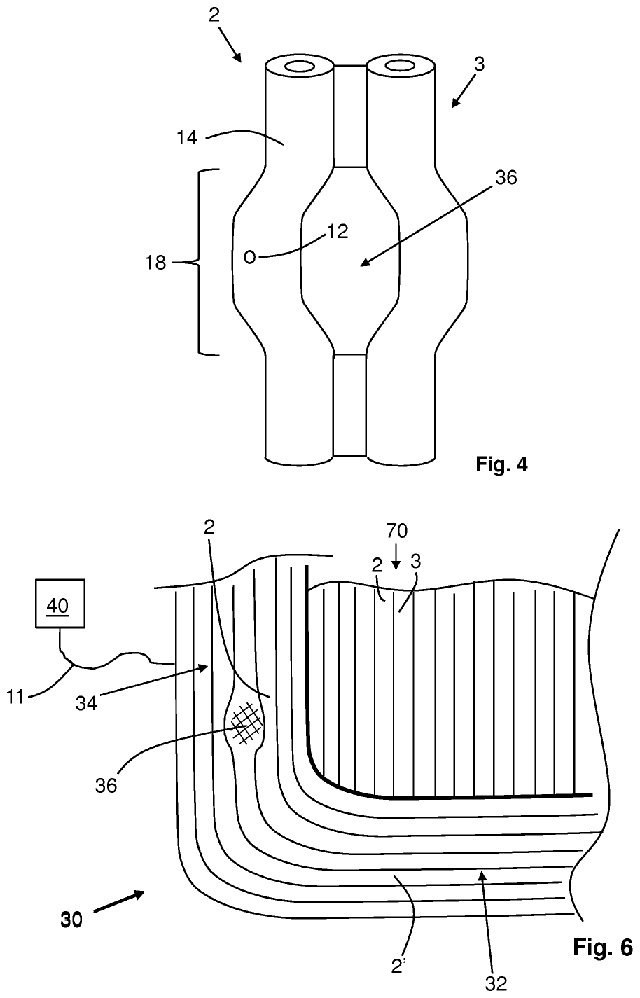

FIG. 4 illustrates a boiler tube 2 according to embodiments. Again, at least a portion of the boiler tube 2 comprises radially inner and outer tubular portions metallurgically bonded to each other, with a sensor space 8 arranged between the radially inner and outer tubular portions. An exit portion 12 of a surface where a duct leading to a sensor space exits, is shown in FIG. 4.

In these embodiments, a first longitudinal tube portion 14 of the boiler tube 2 comprises a bent tube portion 18. The sensor space is arranged in the bent tube portion 18.

When the bent tube portion 18 is arranged adjacent to a further boiler tube 3 in a waterwall of a furnace, an opening 36 may be formed in the waterwall panel. The bent tube portion 18 extends at least partially around the opening 36. Since the sensor space is arranged in the bent tube portion 18, a temperature, and/or stress, at the opening 36 in the waterwall panel may be assessed by a sensor arranged in the sensor space.

A portion of the bent portion 18, the entire bent portion 18, or the entire first longitudinal portion 14, may comprise radially inner and outer tubular portions metallurgically bonded to each other.

FIGS. 7a-7c illustrate various embodiments of a boiler tube unit 70. In FIG. 2a a perspective view of the boiler tube unit 70 is shown. In FIG. 7b a cross section along line B-B in FIG. 7a is shown. FIG. 7c shows a corresponding cross section of a boiler tube unit 70 according to alternative embodiments. In the following discussion reference is made to all of FIGS. 7a-7c, unless reference is specifically made to one or more of FIGS. 7a-7c.

The boiler tube unit 70 comprising a first boiler tube 2 and a second boiler tube 3. The first boiler tube 2 is a boiler tube 2 according to any one of aspects and/or embodiments comprising at least one fin 20 discussed herein. Accordingly, the first boiler tube 2 comprise radially inner and outer tubular portions 4, 6, a sensor space 8, and a duct 10 extending to an exit portion 12 of a surface of the radially outer tubular portion 6. The second boiler tube 3 also comprises radially inner and outer tubular portions 4′, 6′ of the kind discussed herein.

The first and second boiler tubes 2, 3 are connected to each other via the at least one fin 20. As can be seen in the cross sections of FIGS. 7b and 7c, the duct 10 extends from a first side 73 of the at least one fin 20 to an opposite second side 75 of the at least one fin 20. The sensor space 8 is arranged on the first side 73 of the at least one fin 20. The exit portion 12 of the radially outer tubular portion 6 is arranged on the second side 75 of the at least one fin 20.

The boiler tube unit 70 forms a unit ready for installation in a furnace. Thus, when the tube unit 70 is to be installed in a waterwall of a furnace, no welding across the duct 10 is required. Accordingly, neither the duct 10 nor any electrical connection arranged therein will be affected by any heat from a welding operation.

On sides of the first and second boiler tubes 2, 3 opposite to the at least one fin 20, welding may be performed without affecting the duct 10 or any electrical connection arranged therein.

For this purpose, one or both of the first and second boiler tubes 2, 3 may be provided with a further fin 20′, see FIGS. 7b and 7c. The further fin 20′ is configured to be weld to an adjacent boiler tube, either to the fin of an adjacent boiler tube or to a round outer surface of the adjacent boiler tube.

As discussed above with reference to FIGS. 2a-2d, and also shown in FIGS. 7a-7c, the boiler tubes 2, 3 of the boiler tube unit 70 may be provided with one or two fins 20, 20′. The boiler tubes 2, 3 may be said to share the fin 20 and thus, may be said each to be provided with the fin 20.

In the embodiments shown in FIG. 7b, the at least one fin 20 connecting the first and second tubes 2, 3 is formed integrally with the radially outer tubular portions 6, 6′. Thus, when manufacturing the tube unit 70, the radially inner tubular portions 4, 4′ are provided and the radially outer tubular portions 6, 6′ are formed by HIP or additive manufacturing, as is discussed above. In connection with the forming of the radially outer tubular portions 6, 6′ the fin 20 is also formed. Thus, in these embodiments, the fin 20 is formed entirely from the same material as the radially outer tubular portions 6, 6′. The further fins 20′ may also be formed from the same material in connection with the forming of the radially outer tubular portions 6, 6′.

In the embodiments shown in FIG. 7c, the at least one fin 20 connecting the first and second tubes 2, 3 comprises a layer 72 made of the same material as the radially inner tubular portions 4, 4′ of the first and second boiler tubes 2, 3. Thus, for instance heat conductivity between the fin 20 and the boiler tubes 2, 3 may be promoted, when the material of the layer 72 and the radially inner tubular portions 4, 4′ has a superior heat conductivity to that of the radially outer tubular portions 6, 6′.

When manufacturing the tube unit 70, the layer 72 may be welded to the radially inner tubular portions 4, 4′. Thereafter, the radially outer tubular portions 6, 6′ are formed by HIP or additive manufacturing, as discussed above. In connection with the forming of the radially outer tubular portions 6, 6′ also the layer 72, forming a core of the fin 20, is provided with an outer layer 74 of the same material as the radially outer tubular portions 6, 6′. Thus, in these embodiments, the fin 20 is formed from the same two materials as the radially inner and outer tubular portions 4, 4′, 6, 6′.

As discussed above with reference to FIGS. 2a-2d, also in the embodiments of FIGS. 7a-7c the duct 10 may extend along the radially inner tubular portion 4 and thus, may extend underneath the fin 20 seen in a direction along a radial direction of the boiler tube 2 along the fin 20 towards a centre of the boiler tube 2.

In the embodiments of FIG. 7c, A suitably sized opening or recess may be provided in the layer 72 at, or close to, the radially inner tubular portion 4, for the duct 10 to extend from the first side 73 of the fin 20 to the second side 75 of the fin 20 through the opening or recess.

If one or both of the first and second boiler tubes 2, 3 of the boiler tube unit 70 comprises a further fin 20′, as indicated one the right-hand side in FIG. 7c, also the further fin 20′ may be formed in the same manner as the fin 20. That is, with a core layer 72′ of the same material as the radially inner tubular portions 4, 4′ and an outer layer 74′ of the same material as the radially outer tubular portions 6, 6′. The end surface of the further fin 20′ is suitably angled to facilitate welding to adjacent tubes.

On the left-hand side in FIG. 7c it is shown how a fin 20″ may be attached to the first and/or second boiler tube 2, 3 in embodiments wherein one or both of the boiler tubes 2, 3 of the boiler tube unit 70 have a round outer side, i.e. without any integrated further fin 20′. A fin 20″ of an adjacent boiler tube or a separate fin 20″ is welded to the radially outer tubular portion 6, the weld as such as been omitted in FIG. 7c.

The fin 20″ illustrated on the left-hand side in FIG. 7c comprise a first layer 76 and a second layer 78. The first layer 76 is made of the same material as the radially inner tubular portion 4 and the second layer 78 is made of the same material as the radially outer tubular portion 6. The second layer 78 faces towards an inside of a furnace. Thus, the properties of the material of the second outer tubular portion in the second layer are utilised for protecting the fin 20″ from the conditions inside the furnace. The first layer 76 faces an outside of the furnace and thus, is not subjected to the same aggressive environment as the second layer 78. The first layer 76 provides other properties, such as good heat conductivity from the fin 20″ to the first boiler tube 2 and the non-shown adjacent boiler tube.

According to further embodiments, in a similar manner to the left hand fin 20″, also the fin 20 and/or the further fin 20′ may comprise only two layers, one layer made of the same material as the radially inner tubular portions 4, 4′ facing an outside of the furnace, and one layer made of the same material as the radially outer tubular portions 6, 6′ facing an inside of the furnace.

Similar to the first part 5 of the boiler tube 2 discussed in connection with FIGS. 2a-2d, the boiler tube unit 70 may be provided at a short length, such as 10-20 cm, which are metallurgically bonded, e.g. by welding to further lengths of tubes to form a boiler tube unit of e.g. 6-16 m.

Mentioned as examples, in the embodiments of FIG. 7b each the first and second boiler tubes 2, 3 may have an outer diameter of approximately 64 mm and a wall thickness of 7 mm, and may have a distance between their respective centres of approximately 76 mm. A fin 20 made only of the same material as the radially outer tubular portion 6 may have a width of up to approximately 17 mm. The width of the fin 20 is the distance between the first and second boiler tubes 2, 3. In the embodiments of FIG. 7c each of the first and second boiler tubes 2, 3 may have an outer diameter of approximately 76 mm and a wall thickness of 7 mm, and may have a distance between their respective centres of approximately 102 mm. A layer made of the same material as the radially inner tubular portion 4 may be used for fins 20 having a width above approximately 17 mm.

The fin 20 may have a thickness of 4 mm. The radially inner tubular portion 4, 4′ may have a wall thickness of 5 mm and the radially outer tubular portion 6, 6′ may have a wall thickness of 2 mm.

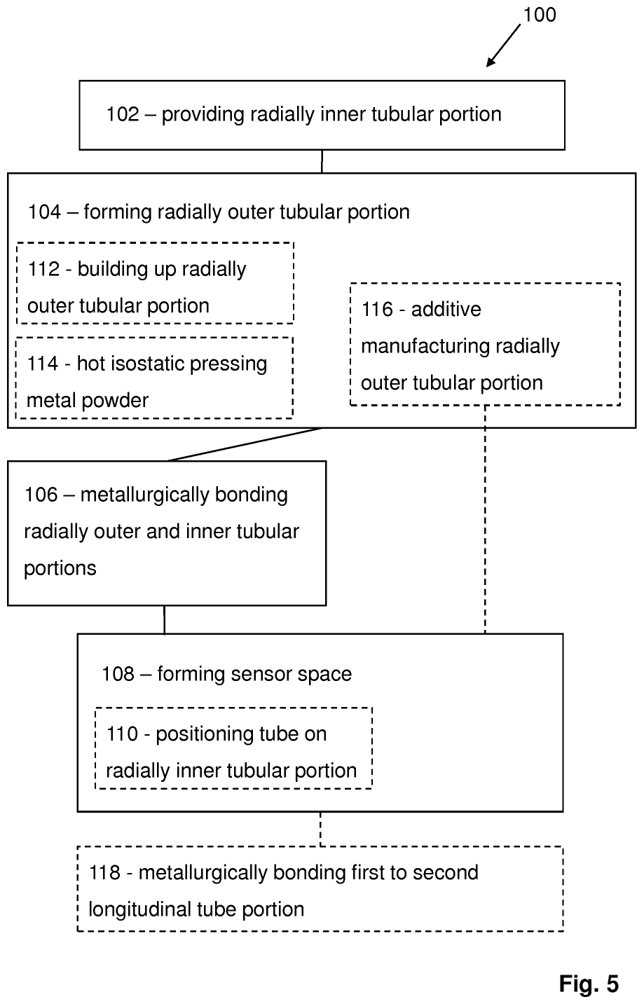

FIG. 5 illustrates embodiments of a method 100 of manufacturing a boiler tube. The boiler tube may be a boiler tube 2 according to any one of aspects and/or embodiments discussed herein. Accordingly, the boiler tube has a longitudinal extension and comprises a radially inner tubular portion extending along at least a first part of the longitudinal extension, and a radially outer tubular portion extending along the first part of the longitudinal extension. The method 100 comprises steps of.
providing 102 the radially inner tubular portion,
forming 104 the radially outer tubular portion,
metallurgically bonding 106 the radially outer tubular portion to the radially inner tubular portion, and
forming 108 a sensor space between the radially inner tubular portion and the radially outer tubular portion, wherein the sensor space is configured to accommodate a sensor arranged to detect a physical property of the radially outer tubular portion.

The step of forming 104 the radially outer tubular portion, and the step of metallurgically bonding 106 the radially outer tubular portion to the radially inner tubular portion may be performed simultaneously. Moreover, also the step of forming 108 a sensor space may be performed simultaneously with the steps of forming 104 the radially outer tubular portion, and of metallurgically bonding 106 the radially outer tubular portion to the radially inner tubular portion.

According to embodiments of the method 100, the step of forming 108 a sensor space may comprise a step of:
positioning 110 a tube partially on the radially inner tubular portion, and the step of forming 104 the radially outer tubular portion may comprise a step of:
building up 112 the radially outer tubular portion around the tube.

Above, with reference to FIG. 2c, a tube 7 is discussed, which is arranged at least partially around the radially inner tubular portion 4.

According to embodiments of the method 100, the step of forming 104 the radially outer tubular portion may comprise a step of:
hot isostatic pressing 114 of a metal powder, whereby the radially outer tubular portion is metallurgically bonded to the radially inner tubular portion.

According to alternative embodiments of the method 100, the step of forming 104 the radially outer tubular portion may comprise a step of:
additive manufacturing 116 of the radially outer tubular portion onto the radially inner tubular portion, and wherein during the step of additive manufacturing 116, the step of forming 108 a sensor space is performed.

According to embodiments of the method 100, wherein the boiler tube comprises a first longitudinal tube portion and a second longitudinal tube portion, and wherein the first longitudinal tube portion comprises the sensor space, the method 100 may comprise a step of:
metallurgically bonding 118 the first longitudinal tube portion to the second longitudinal tube portion. In this manner, the boiler tube having a longitudinal extension L may be manufactured from the first and second longitudinal tube portions. Moreover, the boiler tube may be provided with the sensor space in the first longitudinal tube portion.

FIG. 6 illustrates a furnace 30 according to embodiments. The furnace 30 comprising at least a first waterwall panel 34. The first waterwall panel comprises a number of boiler tubes, wherein at least one first boiler tube 2 of the number of boiler tubes is a boiler tube 2 according to any one of aspects and/or embodiments discussed herein.

According to embodiments, the furnace 30 may comprise a boiler tube unit 70 as discussed above with reference to FIGS. 7a-7c. Accordingly, the at least one first boiler tube 2 forms the first boiler tube 2 of the boiler tube unit 70. The boiler tube unit 70 comprises also the second boiler tube 3.

The furnace 30 may form part of e.g. a boiler, such as a black liquor recovery boiler used in the pulp and paper industry, or of a thermal power plant.

Since the boiler tube comprises a sensor space arranged between the radially inner tubular portion and the radially outer tubular portion, and a sensor may be arranged within the sensor space, a sensor for measuring a temperature of the furnace 30, and/or stress, may be provided in a protected environment.

The first waterwall panel 34 comprises multiple boiler tubes arranged extending in parallel with each other. The boiler tubes are welded indirectly to each other, via fins (not shown in FIG. 6), as discussed above. More than one waterwall panel is arranged around at least part of the furnace 30.

The furnace 30 comprises a second waterwall panel 32. In these embodiments, the first waterwall panel 34 forms at least part of a sidewall of the furnace 30 and the second waterwall panel 32 forms at least part of a floor of the furnace 30.

The first boiler tube 2 is arranged with its sensor space close to an opening 36 in the first waterwall panel 34. In this manner, the temperature, and/or stress, at the opening in the first waterwall panel 34, which may be a particularly exposed portion of the first waterwall panel 34, may be monitored.

The first boiler tube 2 may form part of both the first and the second waterwall panels 32, 34. Alternatively, or additionally, the second waterwall panel 32 may comprise at least one boiler tube 2′ according to any one of aspects and/or embodiments discussed herein.

A temperature on an outer surface of the boiler tube within the furnace 30 is detectable by measuring a temperature of the radially outer tubular portion within the sensor space. The sensor within the sensor space is connected to control, or monitoring, equipment 40 of the furnace 30. A conduit 11 may connect the sensor with the control equipment 40. A known temperature gradient through the wall of the boiler tube, from the outer surface of the boiler tube to the inside of the boiler tube, with knowledge about the radial position of the sensor space, allows the control equipment 40 to calculation the temperature on the outside of the boiler tube based on the temperature sensed by the sensor in the sensor space.

Similarly, stress at an outer surface of the boiler tube within the furnace 30, or at an inner surface of the boiler tube is detectable by measuring stress in the radially outer tubular portion from within the sensor space. The sensor within the sensor space is connected to control, or monitoring, equipment 40 of the furnace 30. A conduit 11 may connect the sensor with the control equipment 40. Known geometry of the wall of the boiler tube, from the outer surface of the boiler tube to the inside of the boiler tube, with knowledge about the radial position of the sensor space, allows the control equipment 40 to calculation the stress at the outside of the boiler tube, and/or at the inside of the boiler tube based on the stress sensed by the sensor in the sensor space.

The temperature, and/or stress, of the first boiler tube 2 may be monitored. Also, the temperature, and/or stress, of one or more further boiler tubes 2′ provided with sensors arranged in sensor spaces, such as the further boiler tube 2′ arranged in the second waterwall panel 32 arranged at the floor of the furnace 30, may be monitored.

The temperature, and/or stress, of the first boiler tube 2, and other boiler tubes 2′, may be continuously monitored in particularly exposed portions of the furnace 30. The continuous monitoring enables furnace operators to increase their knowledge about operating conditions of the furnace 30, and to adjust these in different ways to mitigate negative consequences of certain operating conditions, or process disturbances. A constant measuring of operational data, such as the temperature, and/or stress, of the first boiler tube 2, may enable early warnings and may provide valuable input for planning boiler tube replacements.

The control, or monitoring, equipment 40 comprises a calculation unit which may take the form of substantially any suitable type of processor circuit or microcomputer. The control equipment 40 may comprises a memory unit. The calculation unit is connected to the memory unit, which provides the calculation unit with, for example, stored programme code and/or stored data which the calculation unit needs to enable it to do calculations. The calculation unit may also be adapted to storing partial or final results of calculations in the memory unit, such a one or more temperature values, and/or stress values, measured by the sensor, or sensors, or such as calculated temperatures, and/or stress, at one or more positions inside the furnace 30.

It is to be understood that the foregoing is illustrative of various example embodiments and that the disclosure is defined only by the appended claims. A person skilled in the art will realize that the example embodiments may be modified, and that different features of the example embodiments may be combined to create embodiments other than those described herein, without departing from the scope of the disclosure, as defined by the appended claims. For instance, two sensors may be arranged within the sensor space, e.g. one temperature sensor and one stress sensor.

1. A boiler tube having a longitudinal extension, comprising:
a radially inner tubular portion extending along at least a first part of the longitudinal extension;
a radially outer tubular portion extending along the first part of the longitudinal extension, the radially outer tubular portion being metallurgically bonded to the radially inner tubular portion; and
a sensor space arranged between the radially inner tubular portion and the radially outer tubular portion, wherein the sensor space is configured to accommodate a sensor arranged to detect a physical property of the radially outer tubular portion,
wherein a duct is connected to the sensor space and extends through the radially outer tubular portion to an exit portion of a surface of the radially outer tubular portion,
wherein the radially inner tubular portion and the radially outer tubular portion comprise materials of different chemical composition,
wherein the sensor space and the duct are formed by a tube partially positioned on the radially inner tubular portion and extending through the radially outer tubular portion,
wherein the radially outer tubular portion is built up around the tube, and
wherein the radially outer tubular portion is formed by means of hot isostatic pressing of a metal powder, whereby the radially outer tubular portion is metallurgically bonded to the radially inner tubular portion.

2. The boiler tube according to claim 1, wherein the sensor space is arranged in a first circumferential half of the boiler tube, wherein the duct extends partially around the radially inner tubular portion, and wherein the exit portion is arranged in a second circumferential half of the boiler tube.

3. The boiler tube according to claim 1, wherein the radially outer tubular portion is formed around the radially inner tubular portion, such that the radially outer tubular portion extends circumferentially around the radially inner tubular portion.

4. (canceled)

5. (canceled)

6. The boiler tube according to claim 1, wherein the sensor space and the duct are formed during additive manufacturing of the radially outer tubular portion onto the radially inner tubular portion.

7. The boiler tube according to claim 1, comprising a first longitudinal tube portion and a second longitudinal tube portion, the first longitudinal tube portion and the second longitudinal tube portion extending along the longitudinal extension, wherein the first longitudinal tube portion is metallurgically bonded to the second longitudinal tube portion, and wherein the first longitudinal tube portion comprises the sensor space.

8. The boiler tube according to claim 7, wherein the first longitudinal tube portion comprises a bent tube portion, and wherein the sensor space is arranged in the bent tube portion.

9. The boiler tube according to claim 1, comprising at least one fin extending radially from the radially outer tubular portion and extending at least partially along the longitudinal extension.

10. The boiler tube according to claim 9, wherein the at least one fin is formed integrally with the radially outer tubular portion.

11. The boiler tube according to claim 9, wherein the at least one fin comprises a layer made of the same material as the radially inner tubular portion.

12. A boiler tube unit comprising a first boiler tube and a second boiler tube, wherein the first boiler tube is a boiler tube according to claim 9,
wherein the first and second boiler tubes are connected to each other via the at least one fin, and
wherein the duct extends from a first side of the at least one fin to an opposite second side of the at least one fin.

13. A furnace comprising at least a first waterwall panel, the first waterwall panel comprising a number of boiler tubes, wherein at least one first boiler tube of the number of boiler tubes is a boiler tube according to claim 1.

14. A furnace comprising:
at least a first waterwall panel comprising a number of boiler tubes; and
a boiler tube unit comprising a first boiler tube and a second boiler tube,
wherein the first boiler tube is a boiler tube according to claim 1 including at least one fin extending radially from the radially outer tubular portion and extending at least partially along the longitudinal extension,
wherein the first and second boiler tubes are connected to each other via the at least one fin,
wherein the duct extends from a first side of the at least one fin to an opposite second side of the at least one fin, and
wherein at least one of the number of boiler tubes is the first boiler tube of the boiler tube unit.

15. The furnace according to claim 13, comprising a second waterwall panel, wherein the first waterwall panel forms at least part of a sidewall of the furnace and the second waterwall panel forms at least part of a floor of the furnace.

16. The furnace according to claim 15, wherein the first boiler tube is arranged with its sensor space close to an opening in the first waterwall panel.

17. The boiler tube according to claim 2, wherein the radially outer tubular portion is formed around the radially inner tubular portion, such that the radially outer tubular portion extends circumferentially around the radially inner tubular portion.

18. The boiler tube according to claim 2, wherein the sensor space and the duct are formed during additive manufacturing of the radially outer tubular portion onto the radially inner tubular portion.

19. The boiler tube according to claim 10, wherein the at least one fin comprises a layer made of the same material as the radially inner tubular portion.
